(19) United States
(12) Patent Application Publication
(10) Pub. No.: US 2021/0404345 A1
(43) Pub. Date: Dec. 30, 2021

(54) SCREW ROCKET NOZZLE

(71) Applicant: Thomas Allen GRAVES, Buda, TX (US)

(72) Inventor: Thomas Allen GRAVES, Buda, TX (US)

(21) Appl. No.: 17/316,126

(22) Filed: May 10, 2021

Related U.S. Application Data
(62) Division of application No. 16/393,185, filed on Apr. 24, 2019.
(60) Provisional application No. 62/661,840, filed on Apr. 24, 2018.

(51) Int. Cl. F01D 9/02; F02K 9/97

(52) U.S. Cl. CPC F01D 9/02; F05D 2240/128; F05D 2250/15; F02K 9/97

(57) ABSTRACT

A screw rocket nozzle may include a disc shaped nozzle body and a spiral flow path having an inlet and an outlet. In some examples the flow path is radial with the inlet positioned at a higher pressure region than the outlet.

### CROSS-REFERENCE TO RELATED APPLICATION

1. This application is a divisional of U.S. patent application Ser. No. 16/393,185 filed Apr. 24, 2019, which claims the benefit of U.S. Provisional Application No. 62/661,840, filed Apr. 24, 2018, the entirety of which are fully incorporated by reference herein.

### DECLARATION

Let it be known that I, Thomas Allen Graves of Sand Springs, Okla. am claiming priority of invention in the field of spiral jets or expansion rocket nozzles. My invention is most specifically related to radial expansion type spiral, or screw rocket nozzles, including rocket nozzles applied to turbo-machinery, of this the following is a specification, inclusive of attached drawings.

### BACKGROUND

Radial expansion type rocket nozzles are used in various applications. These applications include power turbine arrangements.

An Impulse, or otherwise impact type turbine may include a radial expansion type rocket nozzle. This nozzle is used to maximize the velocity of a fluid or gas that transfers energy by impact to a rotor, or any secondary resistance mechanism. Pure impulse turbines with radial expansion nozzles include De Laval type impulse steam turbines. Impulse turbines exist also in the form of internal combustion gas turbines. These gas turbines may include a semi-helical formed radial or axial flow path as part of a non-expansive jet, or in part also as expansive rocket nozzle construct.

Reaction turbines have been constructed a with a rotor using a helical formed flow path around an axis of rotation. This flow path is used to accelerate or maintain velocity rotatively against fluid and gas pressure applied at or near the center of rotation and rejected at or near the outside edge of a rotor.

A full helical flow path implies a full turn or spiral of the flow path around an axis of rotation. A semi-helical flow path implies a fractional turn or spiral of the flow path.

A reaction turbine specified in my Supercharging Steam Turbine, or SST provisional application #619-420-28 is a true reaction turbine. All shaft thrust is produced from the rotor by jet reaction. This reaction turbine does not necessarily include a true constant radial expansion rocket nozzle (De Laval type expansion rocket nozzle), however the first prototype of the SST includes true constant radial expansion rocket nozzles. This turbine does not include nearly complete or complete spiral flow paths of the nozzle itself, whether in theory or in practice.

Another example of semi-helical flow path in a reaction turbine rotor is expressed in U.S. Pat. No. 1,329,626 by F. W. Oman. The Oman turbine includes a true constant radial expansion (De Laval type expansion rocket nozzle) rocket nozzle. This turbine does not include nearly complete or complete spiral flow paths.

U.S. Pat. No. 9,035,482 by Joseph Y. Hui, and James M. Hussey III, somewhat epitomizes the field of full helical, or complete spiral or screw type jets. The patent includes turbines having linear expansion in a complete spiral flow path, but does not include the feature of a De Laval type expansion rocket nozzle.

### BRIEF DESCRIPTION OF THE DRAWINGS

FIG. 1 depicts an x-ray frontal view of a screw rocket nozzle in a radial helical form.

FIG. 2 depicts an x-ray side view of a screw rocket nozzle variation having an axial helical form.

FIG. 3 depicts a simplified turbine arrangement.

FIG. 4 shows an axial screw rocket nozzle configured as axial turbine.

### DESCRIPTION OF INVENTION

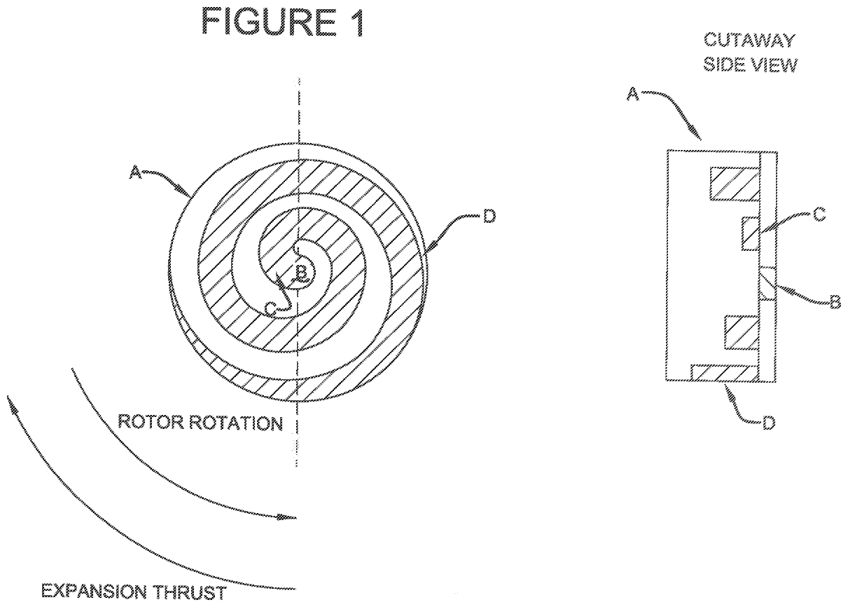

My invention is a screw rocket nozzle having either an axial or radial expansion type helical formed rocket nozzle. FIG. 1 depicts an x-ray frontal view of my screw rocket nozzle in a radial helical form. Referring to FIG. 1;

A: a disc shaped nozzle body

B: a central flow path inlet

C: a flow pathway segment having the lowest overall cross-sectional area

D: exit of the flow pathway and the segment having the highest overall cross sectional area

The cross sectional area of a flow path is increased through the thickness of the disc shaped nozzle body, in this case the frontal view width of each independent helix may be identical, and only the flow path depth varies.

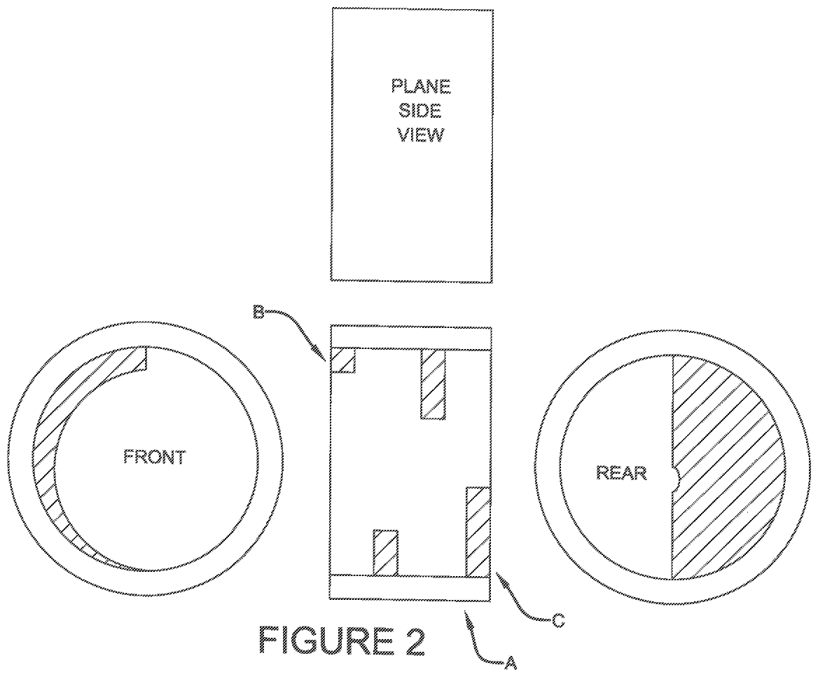

FIG. 2 depicts an x-ray side view of a screw rocket nozzle variation having an axial helical form. Referring to FIG. 2;

A: a cylinder shaped nozzle body

B: an inlet and a flow pathway segment having the lowest overall cross-sectional area

C: an exit and a flow pathway segment having the highest overall cross sectional area

The cross sectional area of a flow path in the variation depicted by FIG. 2 is increased from a minimum at the inlet to a maximum at the exit. This is done by varied depth through the thickness or diameter of a cylinder shaped nozzle body. The width of a flow path in a side view of a cylinder shaped nozzle body remains constant in this example.

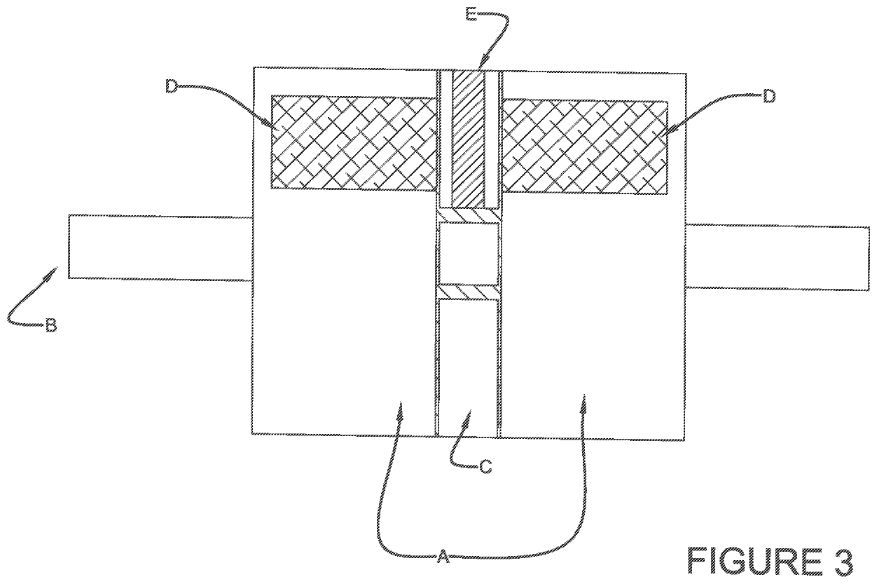

Another alternate embodiment is depicted in FIG. 3. Referring to FIG. 3 an radial screw rocket nozzle type turbine is depicted by; A:

disc shaped nozzle body/rotor

B: turbine shaft

C: stator plate

D: flow path exit

E: inlet runner

In this embodiment 2 disc shaped nozzle body/rotors have open sided flow path facing a close fitting stator. The rotor includes a shaft a in this case. The stator is a plate with a clearance between the shaft and the plate. The stator plate also includes an inlet runner to transmit fluid or gas flow from a supply source to the portion of the disc shaped nozzle body/rotor closest to the shaft.

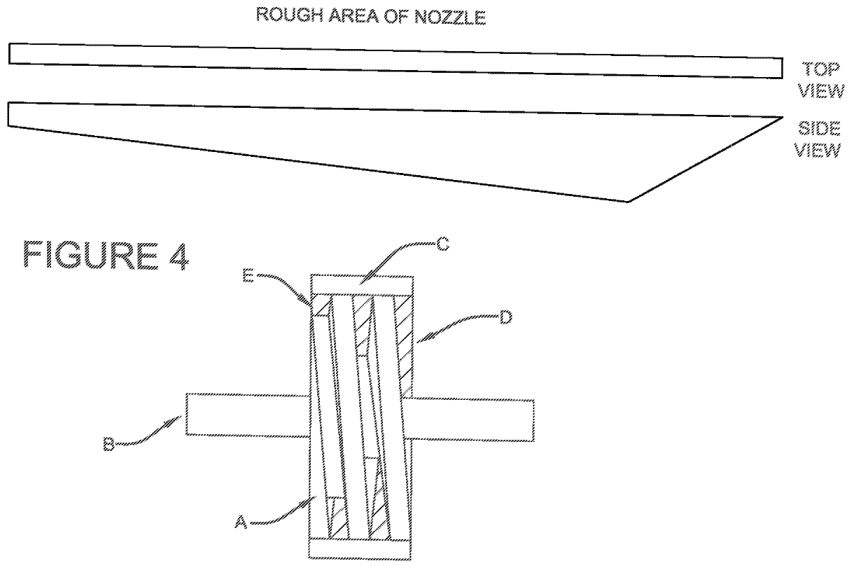

Axial screw rocket nozzle type turbine arrangements are similar except for the nozzle form proper being axial as a cylinder and parallel to an axis of rotation. An axial screw rocket nozzle configured as axial turbine is shown for reference in FIG. 4. Referring to FIG. 4 an axial rocket nozzle type turbine is depicted by;

A: cylinder shaped nozzle bodies/rotors

B: turbine shaft

C: stator cylinder

D: flow path exit

E: inlet

### Method of Operation

A method of operation may include high pressure steam. In FIG. 3 a simplified turbine arrangement is depicted. An inlet runner (E) being charged with high pressure steam will transmit this steam to near the center of a disc shaped nozzle body/rotor (A). The steam pressure will then tend to expand through the nozzle geometry and exhaust to atmospheric pressure at a flow path exit (D). As the steam expands through the disc shaped nozzle body/rotor (A) momentum will produce rotation of a turbine shaft (B) along with the attached disc shaped nozzle body/rotor (A) in the opposite direction of expansion thrust.

1. A screw rocket nozzle comprising:
a disc shaped nozzle body having an interior portion and an exterior portion;
a nearly complete or complete radial spiral flow path having an inlet and an outlet;
wherein:
(1) the inlet is positioned at a first pressure region on the interior portion;
(2) the outlet is positioned at a second pressure region near the exterior portion; and,
(3) the first pressure region is a higher pressure region than the second pressure region.

2. The screw rocket nozzle of claim 1 wherein:
the disc shaped nozzle body has a diameter;
the inlet is positioned near a center of the diameter;
the first pressure region is a highest pressure region of the nozzle; and,
the second pressure region is a lowest pressure region of the nozzle.

3. The screw rocket nozzle of claim 2 wherein:
the nozzle is a De Laval expansion type nozzle.

4. The screw rocket nozzle of claim 3 wherein:
the nozzle rotates about its center as a turbine in an axial configuration.

5. The screw rocket nozzle of claim 4 wherein:
the nozzle is configured as a radial turbine; and,
the nozzle includes a stator.
